(19) United States
(12) Patent Application Publication
(10) Pub. No.: US 2012/0249435 A1
(43) Pub. Date: Oct. 4, 2012

(54) APPARATUS AND METHOD FOR SCROLLING SCREEN OF PORTABLE TERMINAL WITH TOUCH SCREEN

(76) Inventor: In Hyun Nahm, Chungcheongnam-do (KR)

(21) Appl. No.: 13/208,527

(22) Filed: Aug. 12, 2011

(30) Foreign Application Priority Data
Mar. 31, 2011 (KR) 10-2011-0029704

(51) Int. Cl. G06F 3/041

(52) U.S. Cl. 345/173

(57) ABSTRACT

Disclosed herein are an apparatus and a method for scrolling a screen of a portable terminal with a touch screen, which is able to scroll the screen by a desired distance by one touch operation. When user touch is detected in screen scroll command areas, a touch position and time sensor calculates and applies a touch position and time of a user to a scroll direction and distance calculator. The scroll direction and distance calculator calculates and applies a scroll direction and distance of the screen based on the touch position and time received from the touch position and time sensor to a screen scrolling unit. The screen scrolling unit scrolls the screen based on the scroll direction and distance received from the scroll direction and distance calculator. By this configuration, it is possible to scroll the screen by a distance desired by the user by one touch operation and prevent a muscle of a finger or wrist, a ligament of a joint or a fingerprint from being damaged.

### CROSS-REFERENCE TO RELATED APPLICATION

This application claims priority to Korean Patent Application No. 10-2011-0029704, filed on Mar. 31, 2011, and all the benefits accruing therefrom under 35 U.S.C. §119, the contents of which in its entirety are herein incorporated by reference.

### BACKGROUND

1. Field

The present disclosure relates to an apparatus and a method for scrolling a screen of a portable terminal with a touch screen and, more particularly, to an apparatus and a method for scrolling a screen of a portable terminal with a touch screen, which is able to scroll the screen by a distance desired by a user by one touch operation.

2. Description of the Related Art

In general, a touch screen serves as an input device for inputting information and a display device for displaying information on a screen and is a new input device which may replace an input device such as a mouse and a keyboard. The use range of the touch screen has been increased.

With development of techniques, sizes and weights of portable terminals such as tablet PCs, smartphones, personal digital assistants (PDAs) have been gradually decreased.

As the portable terminals have been downsized, the sizes of display screens thereof have been also downsized.

In most portable terminals, in order to increase a display area while downsizing the portable terminal, an on-screen keyboard is displayed on a touch screen.

As described above, if a touch screen is used, since a separate input device is not necessary, it is possible to decrease the size of the portable terminal and increase the size of the screen. Accordingly, recently, portable terminals with a touch screen have come into wide use.

Examples of a method of scrolling a screen of a portable terminal using a touch screen include a method of scrolling a scroll bar displayed on one side of a screen and a dragging method.

In the method of using the scroll bar, a user touches the scroll bar in order to scroll the screen. However, it is inconvenient for the user to touch the scroll bar having a small size.

In the dragging method, when a finger such as a thumb, a forefinger or a ring finger is mainly used when a screen is scrolled. Since an operation for scrolling a screen with a finger is performed using only a part of a muscle of a joint of the finger, large load may be applied to the muscles so as to overwork the muscles or damage a ligament. If the dragging operation is excessively performed, a fingerprint may be damaged.

### SUMMARY

The present disclosure is directed to providing an apparatus and a method for scrolling a screen of a portable terminal with a touch screen, which is able to scroll the screen by a desired distance by one touch operation.

In one aspect, there is provided an apparatus for scrolling a screen of a portable terminal including: a touch position and time sensor configured to detect a touch position and time of a user within screen scroll command areas formed along sides of a touch screen in a band shape; a scroll direction and distance calculator configured to calculate a scroll direction and distance of the screen based on the touch position and time detected by the touch position and time sensor; and a screen scrolling unit configured to scroll the screen based on the scroll direction and distance of the screen calculated by the scroll direction and distance calculator.

In another aspect, there is provided a method for scrolling a screen of a portable terminal with a touch screen including: calculating a touch position and time of a user using a touch position and time sensor if user touch is detected within screen scroll command areas; calculating a scroll direction and distance using a scroll direction and distance calculator based on the touch position and time calculated by the touch position and time sensor; and scrolling the screen using a screen scrolling unit based on the scroll direction and distance calculated by the scroll direction and distance calculator.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a schematic diagram showing the configuration of an apparatus for scrolling a screen of a portable terminal with a touch screen according to an embodiment;

FIGS. 2a to 5b are diagrams illustrating the configuration of the screen of a touch screen according to embodiments; and

FIG. 6 is a flowchart illustrating a method of scrolling a screen of a portable terminal with a touch screen according to an embodiment.

### DETAILED DESCRIPTION

Hereinafter, an apparatus and method for scrolling a screen of a portable terminal with a touch screen according to an exemplary embodiment will be described with reference to the accompanying drawings. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals denote like elements. The shape, size and regions, and the like, of the drawing may be exaggerated for clarity.

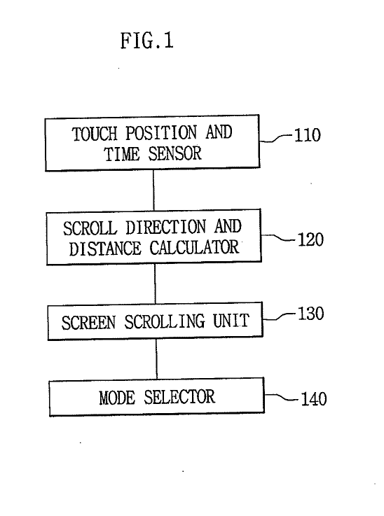

FIG. 1 is a schematic diagram showing the configuration of an apparatus for scrolling a screen of a portable terminal with a touch screen according to an embodiment.

In FIG. 1, a touch position and time sensor 110 detects a touch position and time of a user within screen scroll command areas formed along sides of the touch screen in order to receive a screen scroll command of the user.

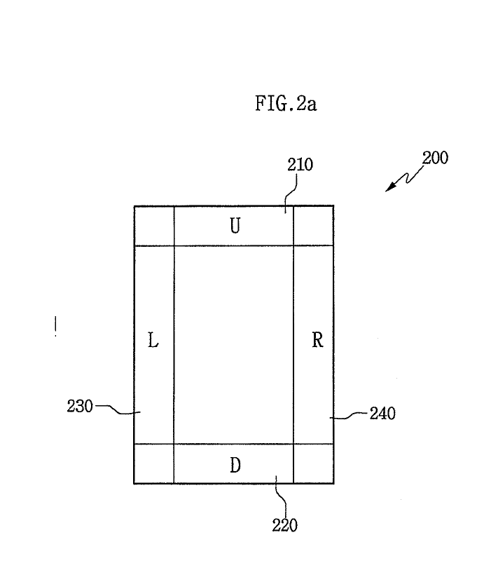

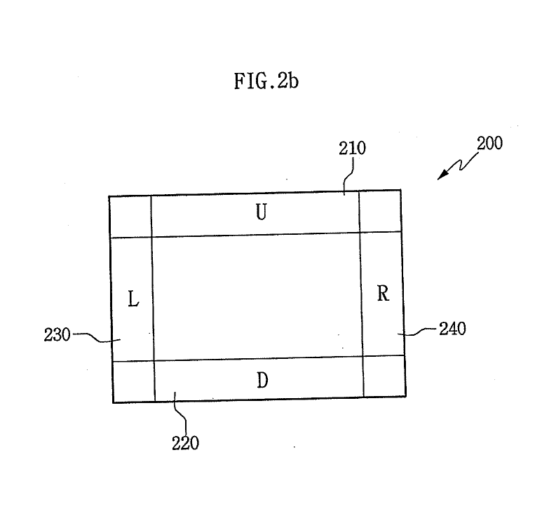

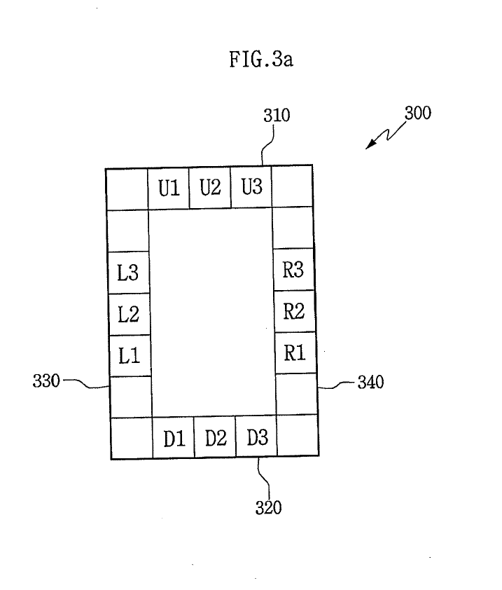

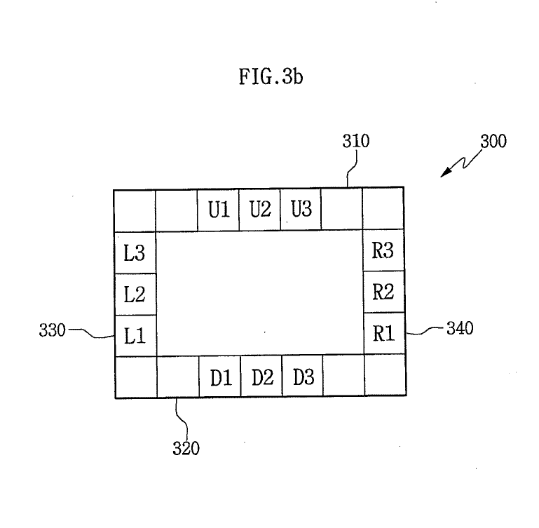

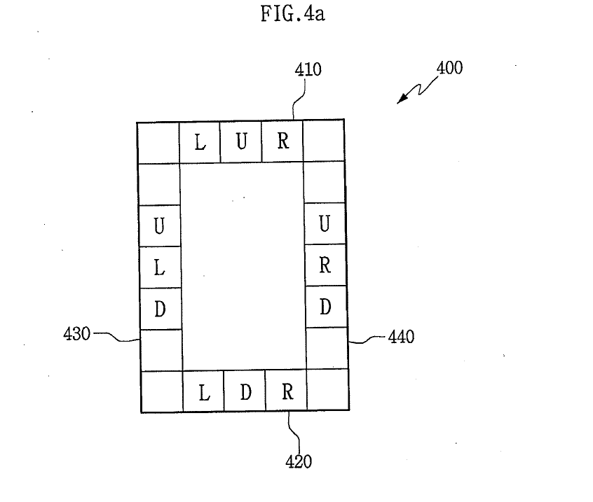

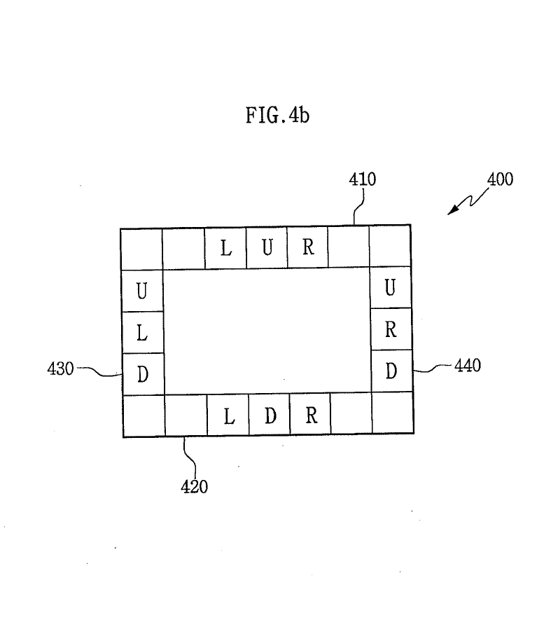

The screen scroll command areas formed along the sides of the touch screen has a band shape. Each screen scroll command area may have a band shape as shown in FIGS. 2a and 2b or may include a plurality of sub areas as shown in FIGS. 3a, 3b, 4a and 4c.

The function for detecting the touch position of the user in the touch position and time sensor 110 is equal to a function for detecting a touch position of a user on a general touch screen and thus a description thereof will be omitted.

A scroll direction and distance calculator 120 calculates a scroll direction and distance of a screen based on the touch position and time detected by the touch position and time sensor 110.

The scroll direction and distance calculator 120 calculates the scroll direction of the screen based on the touch position detected by the touch position and time sensor 110, that is, calculates the scroll direction of the screen depending on which of the screen scroll command areas formed at the sides of the screen is touched by the user. If the touch time detected by the touch position and time sensor 110 is less than a predetermined time, for example. 0.5 seconds, the screen is scrolled by 1/n, for example, ½ or ⅓ in the calculated scroll direction. If the touch time detected by the touch position and time sensor 110 is greater than the predetermined time, the full screen is scrolled in the calculated scroll direction.

If each screen scroll command area includes the plurality of sub areas, the scroll direction and distance calculator 120 calculates the scroll direction of the screen depending on which of the screen scroll command areas formed at the sides of the screen is touched by the user, and calculates the scroll distance of the screen depending on which of the plurality of sub areas is touched by the user.

if each screen scroll command area includes the plurality of sub areas, the scroll direction and distance calculator 120 calculates the scroll direction of the screen depending on which of the plurality of sub areas included in each screen scroll command area is touched by the user, enables the screen to be scrolled by 1/n, for example, ½ or ⅓ in the calculated scroll direction if the touch time detected by the touch position and time sensor 110 is less than a predetermined time, for example, 0.5 seconds, and enables the full screen to be scrolled in the calculated scroll direction if the touch time is greater than the predetermined time.

A screen scrolling unit 130 scrolls the screen based on the scroll direction and distance calculated by the scroll direction and distance calculator 120.

A mode selector 140 sets an operation mode to any one of a normal mode for scrolling a screen by a dragging operation and a body protection mode for scrolling the screen by one touch operation based on an operation mode selected by the user, and sets a switch effect mode to any one of a direct switch mode without a switch effect and a switch effect mode with a switch effect based on a switch effect mode selected by the user.

The operation mode and the switch effect mode may be selected on an initial screen. When any application is being executed, the screen returns to the initial screen and then the operation mode and the switch effect mode may be changed. However, when a specific application is executed, the inherent function of the application may be executed while ignoring the selection of the operation mode and the switch effect mode.

The selection of the operation mode and the switch effect mode is of importance in text or webpage browsing. The selection of the operation mode and the switch effect mode may be supported by an operating system (OS) and an application program interface (API).

FIGS. 2a and 2b are diagrams showing the configuration of a touch screen according to an embodiment, in which screen scroll command areas 210, 220, 230 and 240 for receiving a screen scroll command from a user are formed along sides of the touch screen. That is, a first screen scroll command area 210 is formed along an upper side of the screen, a second screen scroll command area 220 is formed along a lower side of the screen, a third screen scroll command area 230 is formed along a left side of the screen, and a fourth screen scroll command area 240 is formed along a right side of the screen.

As described above, the screen scroll command areas 210, 220, 230 and 240 formed along the sides of the touch screen are set to have different scroll directions. For example, the first screen scroll command area 210 is set to scroll the screen upward according to user touch, the second screen scroll command area 220 is set to scroll the screen downward according to user touch, the third screen scroll command area 230 is set to scroll the screen to the left according to user touch, and the fourth screen scroll command area 240 is set to scroll the screen to the right according to user touch.

If the screen scroll command areas 210, 220, 230 and 240 are formed as shown in FIGS. 2a and 2b, the scroll direction and distance calculator 120 calculates the scroll direction of the screen depending on which of screen scroll command areas 210, 220, 230 and 240 formed at the sides of the screen is touched by the user, calculates the scroll distance based on the touch time detected by the touch position and time sensor 110, enables the screen to be scrolled by 1/n, for example, ½ or ⅓ in the calculated scroll direction if the touch time is less than a predetermined time, for example, 0.5 seconds, and enables the full screen to be scrolled in the calculated scroll direction if the touch time is greater than the predetermined time. For example, if the user pushes the fourth screen scroll command area 240 for less than 0.5 seconds, the scroll direction and distance calculator 120 calculates a result value for scrolling the screen by ½ to the right and provides the result value to the screen scrolling unit 130.

FIGS. 3a and 3b are diagrams showing the configuration of a touch screen according to another embodiment, in which screen scroll command areas 310, 320, 330 and 340 for receiving a screen scroll command from a user are formed along sides of the touch screen and each of the screen scroll command areas 310, 320, 330 and 340 includes a plurality of sub areas. The plurality of sub areas formed at one side of the screen is set to have the same scroll direction, but is set to have different scroll distances according to position. That is, all sub areas D1, D2 and D3 formed in the second screen scroll command area 320 are set to scroll the screen downward by user touch. In terms of the scroll distance, the sub area D1 is set to scroll the screen by ⅓ by user touch, the sub area D2 is set to scroll the screen by ⅔ by user touch, and the sub area D3 is set to scroll the screen by 3/3 by user touch.

In the embodiment, although the screen scroll command areas 310, 320, 330 and 340 are divided into three sub areas, each of the screen scroll command areas 310, 320, 330 and 340 may be divided into n sub areas according to the size of the screen.

As shown in FIGS. 3a and 3b, if each of the screen scroll command areas 310, 320, 330 and 340 is divided into a plurality of sub areas, the scroll direction and distance calculator 120 calculates the scroll direction of the screen depending on which of the screen scroll command areas 310, 320, 330 and 340 formed at the sides of the screen is touched by the user and calculates the scroll distance of the screen depending on which of the plurality of sub areas is touched by the user. For example, if the user pushes the sub area R2 formed in the fourth screen scroll command area 340, the scroll direction and distance calculator 120 calculates a result value for scrolling the screen to the right by ⅔ and provides the result value to the screen scrolling unit 130.

FIGS. 4a and 4b are diagrams showing the configuration of a touch screen according to another embodiment, in which screen scroll command areas 410, 420, 430 and 440 for receiving a screen scroll command from a user are formed along sides of the touch screen and each of the screen scroll command areas 410, 420, 430 and 440 includes a plurality of sub areas. The plurality of sub areas included in each of the screen scroll command areas 410, 420, 430 and 440 is set to have different scroll directions according to position. That is, sub areas U, R and D formed in the fourth screen scroll command area 440 are set to have different scroll directions according to position. The sub area R located at the center of the screen scroll command area is set to scroll the screen to the right by user touch, the sub area U located at the upper side of the sub area R is set to scroll the screen upward by user touch, and the sub area D located at the lower side of the sub area R is set to scroll the screen downward by user touch.

As shown in FIGS. 4a and 4b, if each of the screen scroll command areas 410, 420, 430 and 440 is divided into a plurality of sub areas, the scroll direction and distance calculator 120 calculates the scroll direction of the screen depending on which of the plurality of sub areas included in each of the screen scroll command areas 410, 420, 430 and 440 is touched by the user, calculates the scroll distance of the screen depending on the touch time detected by the touch position and time sensor 110, enables the screen to be scrolled by tin, for example, ½ or ⅓ in the calculated scroll direction if the touch time is less than a predetermined time, for example, 0.5 seconds, and enables the full screen to be scrolled in the calculated scroll direction if the touch time is greater than the predetermined time. For example, if the user pushes the sub area D in the fourth screen scroll command area 440 for less than 0.5 seconds, the scroll direction and distance calculator 120 calculates a result value for scrolling the screen by ½ downward and provides the result value to the screen scrolling unit 130.

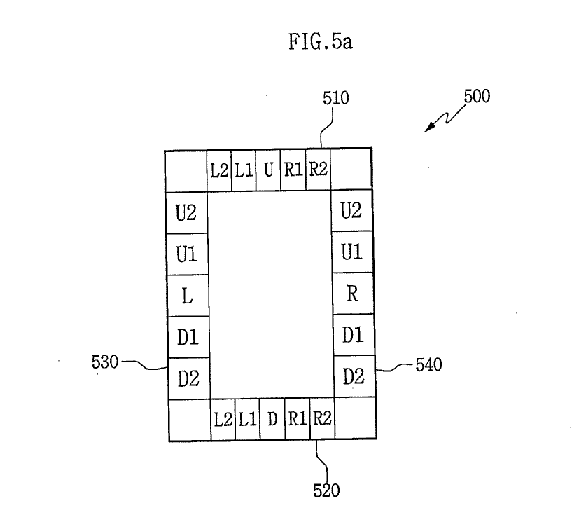

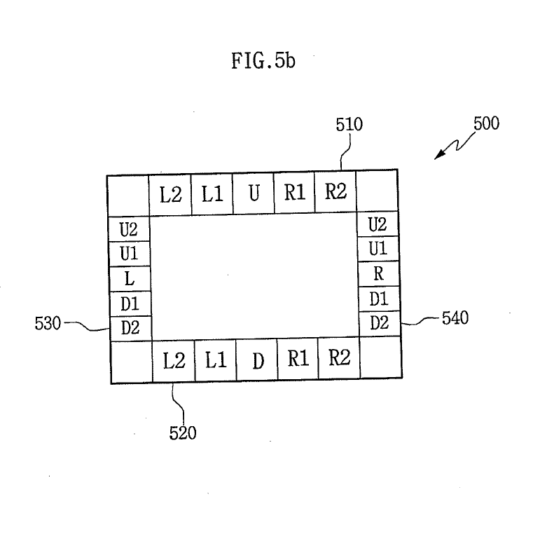

FIGS. 5a and 5b are diagrams showing the configuration of a touch screen according to another embodiment, in which screen scroll command areas 510, 520, 530 and 540 for receiving a screen scroll command from a user are formed along sides of the touch screen and each of the screen scroll command areas 510, 520, 530 and 540 includes a plurality of sub areas. The plurality of sub areas included in each of the screen scroll command areas 510, 520, 530 and 540 is set to have different scroll directions according to position. That is, a sub area R located at the center of the fourth screen scroll command area 540 is set to scroll the screen to the right by user touch, a plurality of sub areas U1 and U2 located at the upper side of the sub area R are set to scroll the screen upward by a predetermined scroll distance by user touch, a plurality of sub areas D1 and D2 located at the lower side of the sub area R are set to scroll the screen downward by a predetermined scroll distance by user touch.

As shown in FIGS. 5a and 5b, if each of the screen scroll command areas 510, 520, 530 and 540 is divided into a plurality of sub areas, the scroll direction and distance calculator 120 calculates the scroll direction of the screen depending on which of the plurality of sub areas included in each of the screen scroll command areas 510, 520, 530 and 540 is touched by the user and calculates the scroll distance of the screen depending on the touch time or touch position. For example, if the user pushes the sub area R of the fourth screen scroll command area 540 for less than 0.5 seconds, the scroll direction and distance calculator 120 calculates a result value for scrolling the screen by ½ to the right and provides the result value to the screen scrolling unit 130 and, if the user pushes the sub area U1 of the fourth screen scroll command area 540, the scroll direction and distance calculator 120 calculates a result value for scrolling the screen by ½ upward and provides the result value to the screen scrolling unit 130.

As described above, the touch screen may be variously implemented and the configuration of the touch screen may be variously changed.

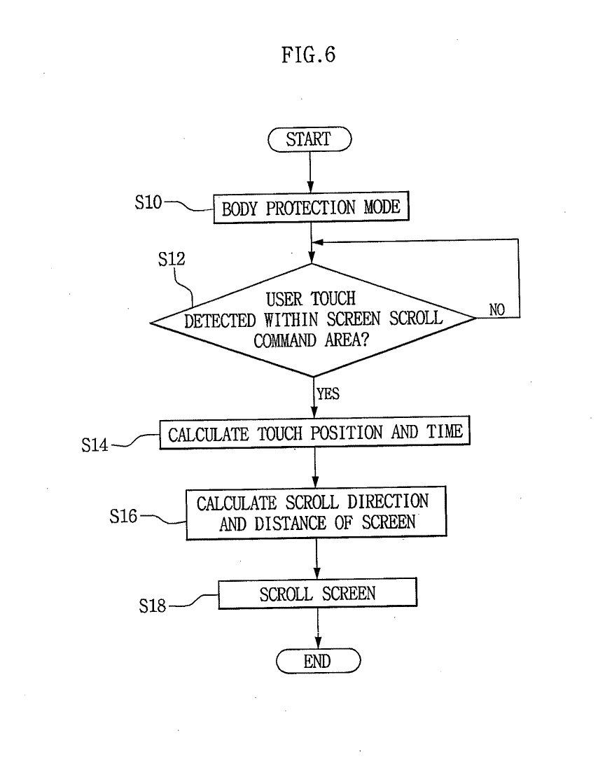

FIG. 6 is a flowchart illustrating a method of scrolling a screen of a portable terminal with a touch screen according to an embodiment.

First, if an operation mode of the portable terminal is set to a body protection mode (S10), the touch position and time sensor 110 determines whether or not user touch is detected within the screen scroll command areas (S12).

If it is determined that user touch is detected within the screen movement command areas in S12, the touch position and time of the user within the screen scroll command areas is calculated (S14).

Next, the scroll direction and distance calculator 120 calculates the scroll direction and distance of the screen based on the touch position and time calculated in S14 (S16).

In S16, if the touch screen is configured as shown in FIGS. 2a and 2b, the scroll direction and distance calculator 120 calculates the scroll direction of the screen depending on which of the screen scroll command areas is touched by the user, calculates the scroll distance of the screen based on the touch time detected by the touch position and time sensor 110, enables the screen to be scrolled by 1/n in the calculated scroll direction if the touch time is less than a predetermined time, and enables the full screen to be scrolled in the calculated scroll direction if the touch time is greater than the predetermined time.

In S16, if the touch screen is configured as shown in FIGS. 3a and 3b, the scroll direction and distance calculator 120 calculates the scroll direction of the screen depending on to which screen scroll command area a sub area touched by the user belongs, and calculates the scroll distance of the screen based on the position where the sub area touched by the user is located in the screen scroll command area.

In S16, if the touch screen is configured as shown in FIG. 4, the scroll direction and distance calculator 120 calculates the scroll direction of the screen based on the scroll direction corresponding to a sub area touched by the user, calculates the scroll distance of the screen based on the touch time detected by the touch position and time sensor 110, enables the screen to be scrolled by 1/n in the calculated scroll direction if the touch time is less than a predetermined time, and the full screen to be scrolled in the calculated scroll direction if the touch time is greater than the predetermined time.

After calculating the scroll direction and distance of the screen in S16, the screen scrolling unit 130 scrolls the screen based on the calculated scroll direction and distance of the screen (S18).

According to an apparatus and a method for scrolling a screen of a portable terminal with a touch screen of the embodiment, it is possible to scroll the screen by a distance desired by a user by one touch operation and to prevent a finger or a wrist from being damaged. In addition, by freely moving a finger so as to actively move a muscle of the finger which was hardly used during a dragging operation, it is possible to relieve fatigue of the finger. By enabling the user to use both hands, it is possible to prevent load from being applied to one hand and prevent a fingerprint from being damaged.

While the exemplary embodiments have been shown and described, it will be understood by those skilled in the art that various changes in form and details may be made thereto without departing from the spirit and scope of the present disclosure as defined by the appended claims.

In addition, many modifications can be made to adapt a particular situation or material to the teachings of the present disclosure without departing from the essential scope thereof. Therefore, it is intended that the present disclosure not be limited to the particular exemplary embodiments disclosed as the best mode contemplated for carrying out the present disclosure, but that the present disclosure will include all embodiments falling within the scope of the appended claims.

What is claimed is:

1. An apparatus for scrolling a screen of a portable terminal, comprising:
a touch position and time sensor configured to detect a touch position and time of a user within screen scroll command areas formed along sides of a touch screen in a band shape;
a scroll direction and distance calculator configured to calculate a scroll direction and distance of the screen based on the touch position and time detected by the touch position and time sensor; and
a screen scrolling unit configured to scroll the screen based on the scroll direction and distance of the screen calculated by the scroll direction and distance calculator.

2. The apparatus according to claim 1, wherein the scroll direction and distance calculator calculates the scroll direction of the screen depending on which of the screen scroll command areas formed along the sides of the touch screen is touched by the user.

3. The apparatus according to claim 2, wherein:
each of the screen scroll command areas includes a plurality of sub areas, and
the scroll direction and distance calculator calculates the scroll distance of the screen depending on which of the plurality of sub areas is touched by the user.

4. The apparatus according to claim 1, wherein:
each of the screen scroll command areas includes a plurality of sub areas, and
the scroll direction and distance calculator calculates the scroll direction of the screen depending on which of the plurality of sub areas included in each of the screen scroll command areas is touched by the user.

5. The apparatus according to claim 2, wherein the scroll direction and distance calculator enables the screen to be scrolled by 1/n in the calculated scroll direction if the touch time detected by the touch position and time sensor is less than a predetermined time, and enables the full screen to be scrolled in the calculated scroll direction if the touch time is greater than the predetermined time.

6. The apparatus according to claim 4, wherein the scroll direction and distance calculator enables the screen to be scrolled by 1/n in the calculated scroll direction if the touch time detected by the touch position and time sensor is less than a predetermined time, and enables the full screen to be scrolled in the calculated scroll direction if the touch time is greater than the predetermined time.

7. The apparatus according to claim 1, further comprising a mode selector configured to set an operation mode to any one of a normal mode for scrolling the screen by a dragging operation and a body protection mode for scrolling the screen by one touch operation based on an operation mode selected by the user, and to set a switch effect mode to any one of a direct switch mode without a switch effect and a switch effect mode with a switch effect based on a switch effect mode selected by the user.

8. A method for scrolling a screen of a portable terminal with a touch screen, comprising:
calculating a touch position and time of a user using a touch position and time sensor if user touch is detected within screen scroll command areas;
calculating a scroll direction and distance using a scroll direction and distance calculator based on the touch position and time calculated by the touch position and time sensor; and
scrolling the screen using a screen scrolling unit based on the scroll direction and distance calculated by the scroll direction and distance calculator.
